(19) United States
(12) Patent Application Publication
(10) Pub. No.: US 2024/0192356 A1
(43) Pub. Date: Jun. 13, 2024

(54) METHODS AND SYSTEMS FOR INDIRECTLY PROFILING A SECONDARY SURVEILLANCE RADAR (SSR) AND DETERMINING A POSITION OF AN AIRCRAFT USING THEREOF

(71) Applicant: SEAMATICA AEROSPACE LTD., St. John's (CA)

(72) Inventors: Siu Donald O'YOUNG, St. John's (CA); Yake LI, Ottawa (CA)

(21) Appl. No.: 18/442,688

(22) Filed: Feb. 15, 2024

Related U.S. Application Data
(63) Continuation-in-part of application No. 17/577,250, filed on Jan. 17, 2022.
(63) Continuation-in-part of application No. 17/730,156, filed on Apr. 26, 2022.
(60) Provisional application No. 63/485,237, filed on Feb. 15, 2023.

(51) Int. Cl. G01S 13/78; G01S 13/76

(52) U.S. Cl. CPC G01S 13/784; G01S 13/762; G01S 13/765; G01S 13/767

(57) ABSTRACT

Methods and systems for determining a Pulse Repetition Frequency (PRF) pattern of a Secondary Surveillance Radar (SSR) are disclosed, when an ownship aircraft is not being able to receive interrogation signals from the SSR. Instead, a transponder equipped opportunistic aircraft with Automatic Dependent Surveillance-Broadcast (ADS-B) Out functionality is used, which is in the line-of-sight with both the SSR and the ownship aircraft. The opportunistic aircraft is interrogated during one or more rotations of the SSR, when within a beam of the SSR. At the ownship, the transponder response signals from the opportunistic aircraft are collected, and the position of the opportunistic aircraft is decoded from ADS-B Out messages. The PRF of the SSR is determined using the collected transponder response signals, the decoded position of the opportunistic aircraft, a position of the ownship and a position of the SSR, and a predetermined transponder response time at the opportunistic aircraft.

### CROSS-REFERENCE TO RELATED APPLICATIONS

The present application is a continuation in part of U.S. patent application Ser. No. 17/577,250, titled “AVIATION DETECT AND AVOID METHOD AND SYSTEM”, filed Jan. 17, 2022 (attorney docket number SEA-008-US) and U.S. patent application Ser. No. 17/730,156, titled “METHOD AND APPARATUS FOR DETERMINING A POSITION OF AN AIRBORNE VEHICLE USING SECONDARY SURVEILLANCE RADARS AS BEACONS filed Apr. 26, 2022” (attorney docket number SEA-006-US). Also, the present application claims the benefit from the U.S. provisional application 63/485,237 filed Feb. 15, 2023 (attorney docket number SEA-009-US-prov). The entire contents of the above noted applications are incorporated herein by reference.

### FIELD OF THE INVENTION

The present invention relates to the aviation industry, and in particular to the methods and systems for indirectly profiling a Secondary Surveillance Radar (SSR), without receiving direct interrogation signals from the SSR, and for determining a position of a target aircraft using the indirectly profiled SSR.

### BACKGROUND OF THE INVENTION

Secondary Surveillance Radar (SSR) systems have been used around the world in air traffic control applications to track positions of an aircraft in the sky and inform pilots in other aircraft accordingly. Precision and efficiency of such tracking systems are particularly crucial at and near the airports where a higher density of flying objects (small or large planes, helicopters, etc.) are present. As such, the SSR systems are often supplemented with other auxiliary systems. Such auxiliary system is a Passive Secondary Surveillance Radar (PSSR) system that operates as a slave system to the conventional master SSR system.

According to the aviation standards, such as the “Minimum Operational Performance Standards (MOPS) for Air Traffic Control Radar Beacon System (ATCRBS) Airborne Equipment” from Radio Technical Commission for Aeronautics (RTCA, Inc.), an air traffic control system comprises an SSR main rotating antenna transmitting narrow interrogation beams which is assisted with an omni-directional antenna transmitting a related signal. The air traffic control relies on transponders located in an aircraft to reply to interrogation signals, for example at 1030 MHz, to convey their identity as well as their altitude. The transponder reply signal is broadcast at another standard frequency, for example, 1090 MHz. Every interrogation message is composed of three pulses, P1, P2 and P3 at a given standard frequency, for example 1030 MHz. P1 and P3 pulses can only be received when the aircraft is in the coverage of a main antenna beam, a main lobe width of 2 to 3 degrees. Outside of the main lobe, P1 and P3 are weaker than the P2 pulse. This means that a target object, for example, a target aircraft can only receive valid interrogation from the SSR, and then respond when it is in the main lobe of the main antenna beam. The P2 pulse, also referred to as Side Lobe Suppression (SLS) signal, is synchronized with the P1 pulse and transmitted by the omni-directional antenna (hence referred to as omni signal) exactly 2 μs after the P1 pulse. The P3 pulse is used to determine whether the current message is a mode A or mode C interrogation by delaying with different time intervals (8 μs or 21 μs) from a corresponding P1 pulse. In a transponder, that an aircraft is obliged to have, if a received P2 is weaker than P1 by 9 dB, a response to the interrogation is sent; otherwise, the interrogation is ignored. The delay between a reception of the interrogation pulse and the transmission of the reply or response is exactly 3 μs for any transponder. Also, the interrogation time interval is large enough that a response to an interrogation will surely be received before the next interrogation is sent.

The SSR antenna and system have evolved for decades including hardware modifications to omni-directional antennas and various interrogation patterns, including staggered interrogation pattern.

To avoid ambiguity or interference in crowded air space, the SSR normally staggers the time intervals between successive interrogations in a fixed pattern. This is referenced as “staggered pattern” or “pulse repetition frequency (PRF) pattern” in the present application. The staggered pattern may differ for different SSR configurations and providers.

Therefore, there is a need to develop improved methods and SSR system that would work reliably for new hardware designs of omni-directional antennas and staggered interrogation patterns.

A particular problem arises when a PSSR is not capable of receiving direct interrogation signals from the SSR, and the PSSR is required to track a target aircraft.

### SUMMARY OF THE INVENTION

An object of the invention is to indirectly profile a Secondary Surveillance Radar (SSR) using signals from an opportunistic transponder-equipped aircraft with a known position. A related object is to determine a position of a target transponder equipped aircraft using the indirectly profiled SSR, the target aircraft receiving direct interrogation signals from the SSR.

According to one aspect of the invention, there is provided a system for indirect profiling a Secondary Surveillance Radar (SSR), comprising:

a Passive Secondary Surveillance Radar (PSSR), the PSSR not being able to receive interrogation signals from the SSR;
an opportunistic aircraft, which is:
(i) equipped with a transponder and has an Automatic Dependent Surveillance-Broadcast (ADS-B) Out functionality;
(ii) in the Line-of-Sight (LOS) with both the SSR and the PSSR;
(iii) interrogated with the interrogation signals from the SSR, when the opportunistic aircraft is within a beam of the SSR during one or more rotations of the SSR;
   the PSSR comprising:
(a) means for collecting transponder response signals from the opportunistic aircraft to said interrogation signals from the SSR during said one or more rotations of the SSR;
(b) means for receiving an ADS-B Out response from the opportunistic aircraft and decoding a spatial position of the opportunistic aircraft from the ADS-B Out response;
(c) means for determining a staggered Pulse Repetition Frequency (PRF) pattern of the SSR using the collected transponder response signals, the decoded spatial position of the opportunistic aircraft, a position of the ownship and a position of the SSR, and a predetermined transponder response time at the opportunistic aircraft.

In the system described above, the interrogation signals are at 1030 MHz, and the transponder response signals are at 1090 MHz.

The PSSR may be located at an ownship aircraft or on the ground, for example at a ground base station.

In the system described above, the ownship is equipped with one of:
Global Positioning System (GPS); or
ADS-B Out functionality;
for determining the position of the ownship.
   In the system described above, the beam of the SSR is a main beam of the SSR, or a Side Lobe Suppression (SLS) omni directional beam of the SSR.
   The system further comprises:
means for receiving a reply from a target aircraft in response to an interrogation signal sent by the SSR to the target aircraft;
estimating a transmit time of the interrogation signal to the target aircraft based on a reception time of said reply, and the PRF pattern; and
means for determining the position of the target aircraft using an altitude informationhof the target object contained in said reply, the position of the SSR, said estimated transmit time of the interrogation signal, and said reception time of said reply.

The system further comprises means for determining a location of the ownship using two or more opportunistic aircraft interrogated by the same or different SSRs.

In the system described above, the ownship is blocked from a Line of Sight (LOS) of the SSR.

According to another aspect of the invention, there is provided a method for indirect profiling a Secondary Surveillance Radar (SSR), comprising:

at a Passive Secondary Surveillance Radar (PSSR), the PSSR not being able to receive interrogation signals from the SSR:
(a) collecting transponder response signals from an opportunistic aircraft; the opportunistic aircraft being:
(i) equipped with a transponder and has an Automatic Dependent Surveillance-Broadcast (ADS-B) Out functionality;
(ii) in the Line-of-Sight with both the SSR and the PSSR; and
(iii) interrogated, during one or more rotations of the SSR, with interrogation signals from the SSR when the opportunistic aircraft is within a beam of the SSR;
   (b) receiving an ADS-B Out response from the opportunistic aircraft and decoding a spatial position of the opportunistic aircraft from the ADS-B Out response;
   (c) determining a staggered Pulse Repetition Frequency (PRF) pattern of the SSR using the collected transponder response signals, the decoded spatial position of the opportunistic aircraft, a position of the ownship and a position of the SSR, and a predetermined transponder response time at the opportunistic aircraft.

In the method described above, the interrogating comprises interrogating at 1030 MHz, and collecting comprises collecting the transponder response signals at 1090 MHz.

The method further comprises placing the PSSR at an ownship aircraft, or at a ground base station.

The method further comprises determining a location of the ownship using two or more opportunistic aircraft interrogated by the same or different SSRs.

In the method described above, the beam of the SSR is a main beam of the SSR, or a Side Lobe Suppression (SLS) omni directional beam of the SSR.

The method further comprises:
receiving a reply from the target aircraft in response to an interrogation signal sent by the SSR to the target aircraft;
estimating a transmit time of the interrogation signal to the target aircraft based on a reception time of said reply, and the PRF pattern; and
determining the position of the target aircraft using an altitude informationhof the target object contained in said reply, the position of the SSR, said estimated transmit time of the interrogation signal, and said reception time of said reply.

In the method described above, the ownship is blocked from a Line of Sight (LOS) of the SSR.

According to yet another aspect of the invention, there is provided a Passive Secondary Surveillance Radar (PSSR), not being able to receive interrogation signals from a Secondary Surveillance Radar (SSR), the PSSR comprising:
(a) means for collecting transponder response signals from an opportunistic aircraft to interrogation signals from the SSR during one or more rotations of the SSR;
   the opportunistic aircraft is:
   (i) equipped with a transponder and has an Automatic Dependent Surveillance-Broadcast (ADS-B) Out functionality;
   (ii) in the Line-of-Sight with both the SSR and the PSSR;
   (iii) interrogated with the interrogation signals from the SSR, when the opportunistic aircraft is within a beam of the SSR during said one or more rotations of the SSR;
(b) means for receiving an ADS-B Out response from the opportunistic aircraft and decoding a spatial position of the opportunistic aircraft from the ADS-B Out response;
(c) means for determining a staggered Pulse Repetition Frequency (PRF) pattern of the SSR using the collected transponder response signals, the decoded spatial position of the opportunistic aircraft, a position of the ownship and a position of the SSR, and a predetermined transponder response time at the opportunistic aircraft.

The PSSR may be placed on the ground, for example at the ground base station, or on an ownship aircraft.

Thus, an improved method and system for indirect profiling the SSR have been provided, and for determining a position of a target aircraft.

### BRIEF DESCRIPTION OF THE DRAWINGS

Embodiments of the present invention will be further described with reference to the accompanying exemplary drawings, in which:

FIG. 1 illustrates a scenario where a first aircraft, identified as an “ownship” equipped with a Passive Secondary Surveillance Radar (PSSR), and a second aircraft equipped with an “ADS-B-out” instrument, are within range of an SSR, however, the ownship is temporarily unable to receive interrogation signals from a Secondary Surveillance Radar (SSR) along a direct line-of-sight (LOS) path due to an obstruction;

FIG. 2 illustrates a scenario where a PSSR in a ground station and an aircraft equipped with an “ADS-B-out” instrument, are within range of an SSR, however, the PSSR is unable to receive interrogation signals from an SSR along a LOS path due to an obstruction;

FIG. 3 illustrates components of a mobile PSSR comprising a module for identifying a pulse repetition frequency pattern (PRF pattern) of an SSR within reach of the mobile PSSR, in accordance with an embodiment of the present invention;

FIG. 4 illustrates a scheme for determining PRF patterns of multiple SSR within reach of a PSSR, in accordance with an embodiment of the present invention;

FIG. 5 illustrates a first method of synthesizing a PRF pattern of a specific SSR from detected random fragments of the PRF pattern, in accordance with an embodiment of the present invention;

FIG. 6 illustrates head-fusing of two fragments into a string and tail fusing of two fragments to produce strings for further fusing with other fragments;

FIG. 7 illustrates continued fusing of a string formed in FIG. 4 from two fragments with a third fragment to form a lengthened string;

FIG. 8 illustrates an exemplary PRF pattern and randomly detected fragments of the PRF pattern, for use in an embodiment of the present invention;

FIG. 9 illustrates a second method of synthesizing a PRF pattern of a specific SSR from detected random fragments of the PRF pattern, the second method expedites the synthesis process and enables synthesis of multiple PRF patterns, in accordance with an embodiment of the present invention;

FIG. 10 illustrates application of the method of FIG. 9 to synthesize a PRF pattern from the detected fragments of FIG. 8;

FIG. 11 is a continuation of FIG. 10;

FIG. 12 is a continuation of FIG. 11;

FIG. 13 is a continuation of FIG. 12;

FIG. 14 illustrates a criterion for verifying PRF-pattern periodicity within a string, in accordance with an embodiment of the present invention;

FIG. 15 is a continuation of FIG. 14;

FIG. 16 illustrates an outcome of an application of the method of FIG. 9 based on detected fragments of two distinct PRF patterns, the outcome enabling synthesizing the two distinct PRF patterns, in accordance with an embodiment of the present invention;

FIG. 17 illustrates the scenario of FIG. 1 with a target aircraft appearing within communication range of both the SSR and the ownship;

FIG. 18 illustrates the scenario of FIG. 2 with a target aircraft appearing within communication range of both the SSR and the ownship; and

FIG. 19 illustrates a scenario similar to the scenario of FIG. 1 but with absence of an obstruction of LOS transmission from the SSR to the ownship, the ownship comprising a transponder and a PSSR, however, the position of the PSSR above the ownship fuselage does not permit reception of signals (at 1030 MHz) from the SSR.

### TERMINOLOGY

“Profiling an SSR”: The term refers to determining a “staggered pattern” or a “pulse repetition frequency (PRF) pattern” of the SSR, when time intervals between successive interrogations of the SSR are staggered in a fixed pattern, the PRF being used to define a specific SSR and avoid ambiguity or interference in crowded air space. The staggered, or PRF pattern may differ for different SSR configurations and air navigation service providers (ANSPs).

“Indirectly profiling an SSR”: The term refers to determining the PRF pattern of the SSR, when the PSSR does not have a Line-of-Sight path to the SSR, or for some other reasons when direct interrogations from the SSR cannot be observed at the PSSR. The term may also refer to determining the PRF pattern of the SSR when, for any reason, the PSSR does not rely on direct interrogations from the SSR, even when the SSR is in the Line of Sight of the PSSR, but instead uses transponder reply signals from the opportunistic aircraft 115.

“Opportunistic” aircraft: The term refers to an aircraft that is within communication reach for receiving interrogation signals from an SSR and also within communication reach to send transponder reply signals to a PSSR onboard the ownship.

### DETAILED DESCRIPTION

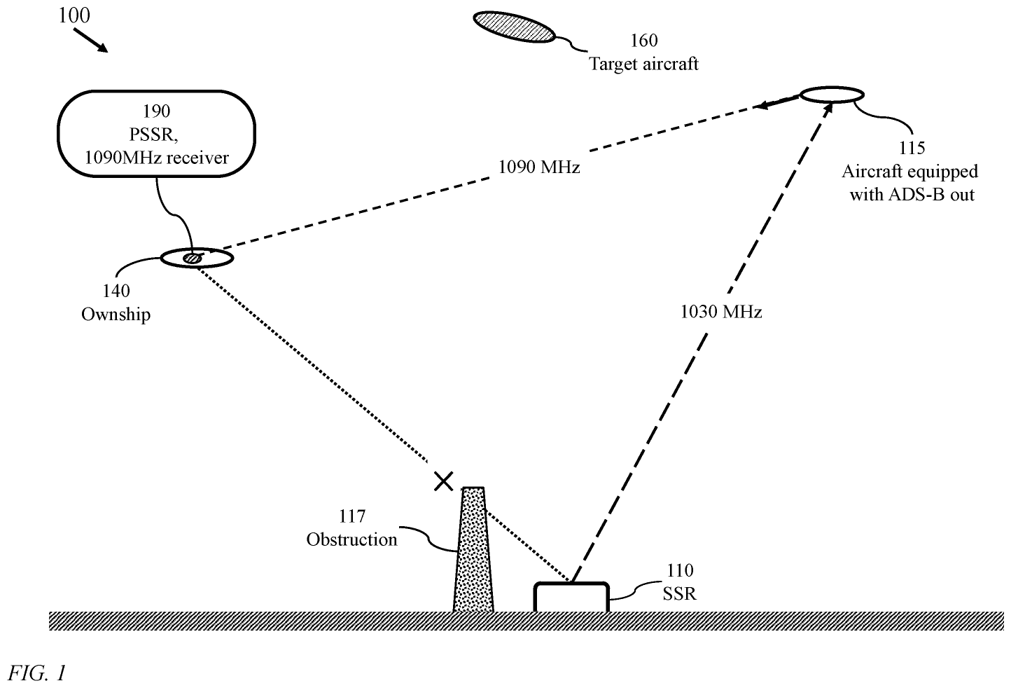

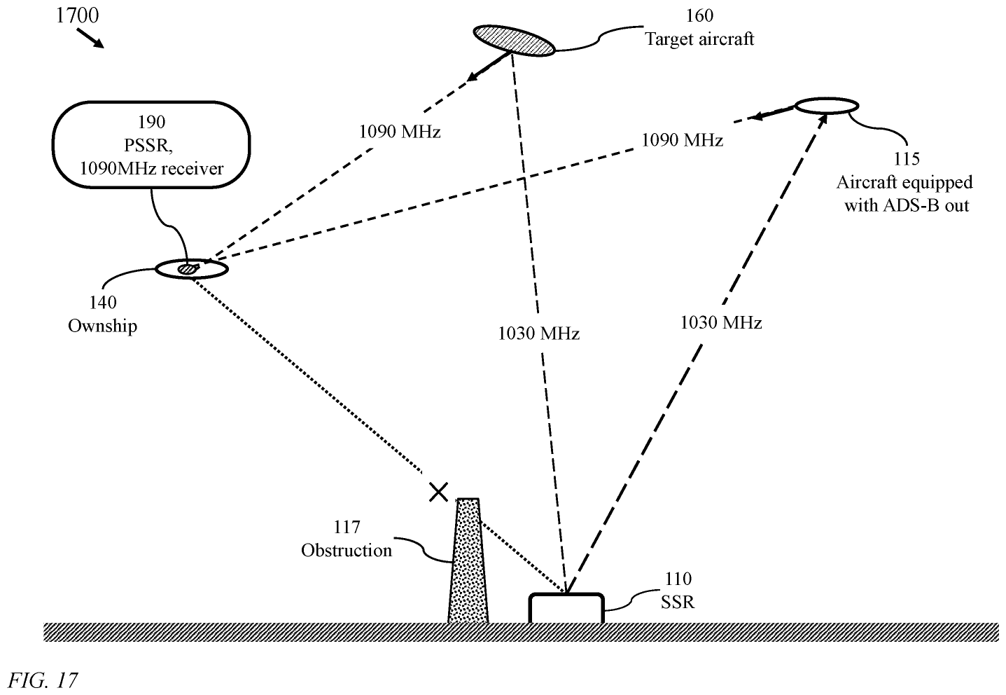

FIG. 1 illustrates a scenario 100 where a first aircraft 140, identified as an “ownship” equipped with a Passive Secondary Surveillance Radar (PSSR) 190, and a second aircraft 115, are within communication range of a Secondary Surveillance Radar (SSR) 110, however, the ownship 140 is temporarily unable to monitor interrogations from SSR 110 along a direct line-of-sight (LOS) path due to an obstruction 117. The second aircraft 115 is equipped with a transponder and an Automatic Dependent Surveillance-Broadcast (ADS-B) devices, specifically an ADS-B-out device. One of the objectives of the present invention is to enable the ownship 140 to profile SSR 110 despite the absence of a communication path from the SSR 110 to the ownship 140 due to the obstruction 117. To realize this objective, the PSSR relies on detecting signals received from the second air craft. The second aircraft is herein referenced as an “opportunistic” aircraft. A target aircraft 160 is also illustrated, the position of which is to be determined as described below with reference to FIG. 17.

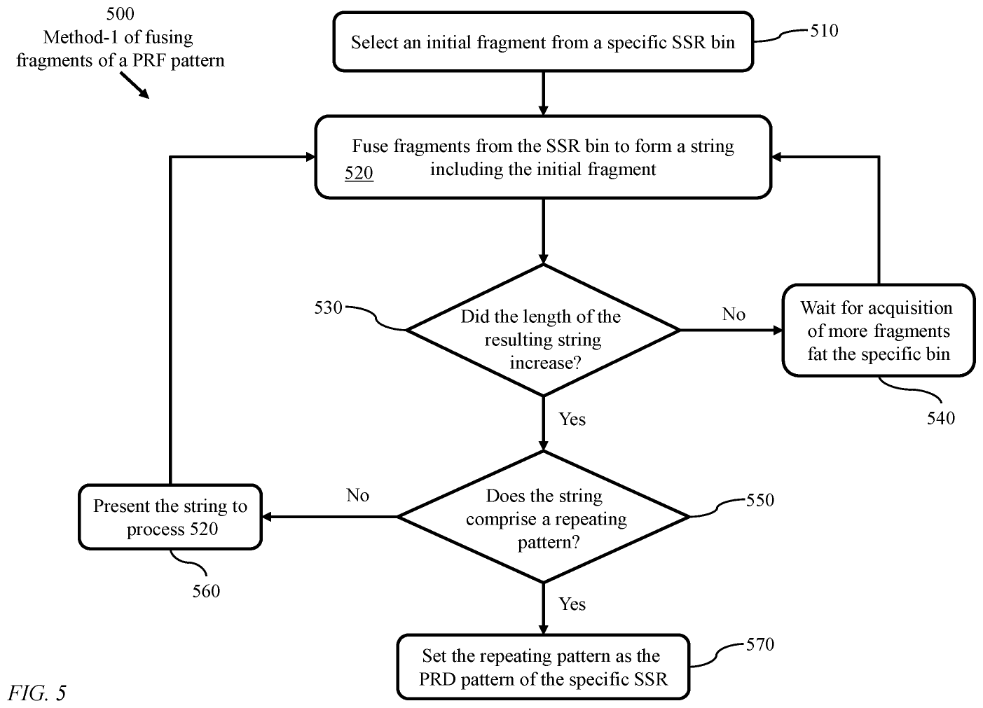

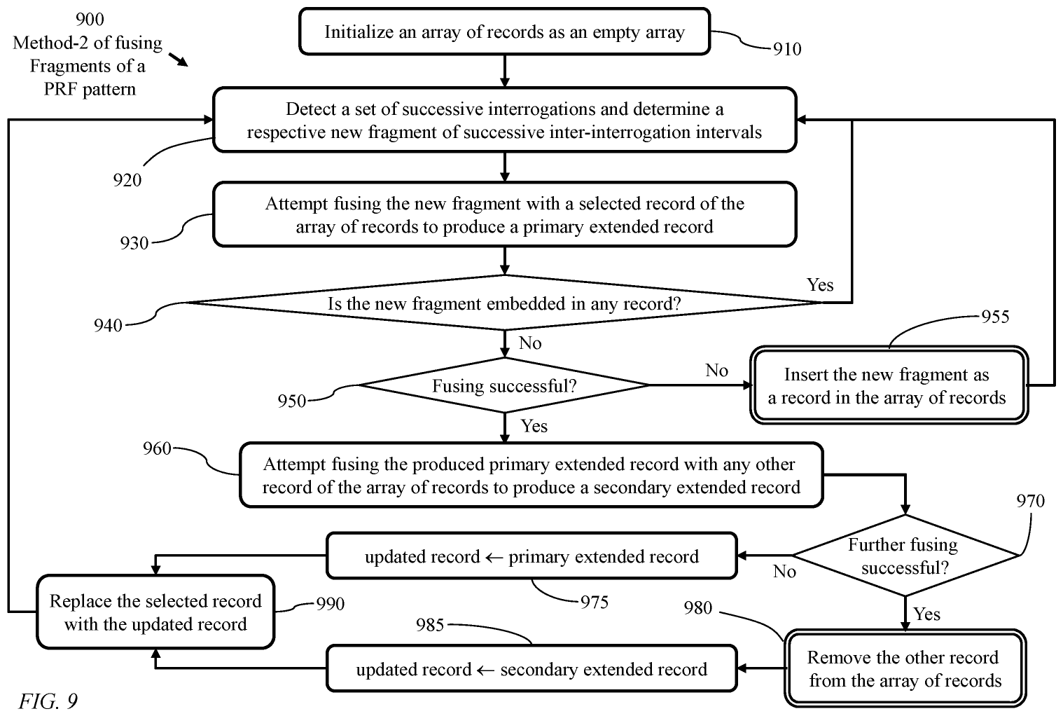

The SSR 110 transmits interrogation signals at 1030 MHz, which are received at the opportunistic transponder-equipped aircraft 115. The transponder of the opportunistic aircraft 115 responds to the SSR interrogations with 1090 MHz response signals. The response signals from the opportunistic aircraft 115 are received at the ownship aircraft 140 and processed by a Passive Secondary Surveillance Radar (PSSR) device 190 installed at the ownship aircraft 140. In particular, the PSSR 190 determines the PRF pattern of the SSR 110, as describe below with reference to FIG. 5 (method-1) or FIG. 9 (method-2).

As illustrated in FIG. 1, the ownship aircraft 140 is blocked from the Line of Sight (LOS) path from SSR 110 by obstruction 117 (for example a mountain, a building or similar), but the opportunistic aircraft 115 which is transponder-equipped and has ADS-B out happens to have a LOS to the SSR 110 and a LOS path to the ownship 140.

The PSSR 190 uses 1090 MHz responses from the opportunistic aircraft 115 to indirectly profile the pattern and align timing of the PRF of the SSR 110.

The PSSR 190 can also profile a mechanical spinning speed and bearing of the main beam from the blocked SSR 110, which requires a single-frequency 1090 MHz receiver along with corresponding calculations. Although both the ownship aircraft 140 and the opportunistic aircraft 115 are moving objects, they can be treated as stationary objects for the following reasons.

Since the main beam from the SSR is narrow, for example 1°,the duration of the opportunistic aircraft 115 in the main beam of the SSR 110 will be (τ/360) where τ is the period of the rotation of the SSR 110. For the SSR 110 rotating at 12.5 rpm, τ=4.8 sec and (τ/360)=13 msec.

For example, if the opportunistic aircraft 115 travels at 500 kts (knots), it would have moved only 3.25 meters in 13 msec. The same would apply to the ownship aircraft 140. With the lengths of the 1030 MHz and 1090 MHz paths being in knots (a knot is a nautical mile, 1.8 Km), the opportunistic aircraft 115 may be approximated as being stationary while in the main beam of the SSR 110.

Thus, since the position of the opportunistic aircraft 115 is known to the ownship aircraft 140 via decoded ADS-B messages, and the ownship aircraft 140 has a position of the SSR 110 stored in its database and also knows its own position, the PRF and the spinning of the SSR 110 may be profiled as if the ownship aircraft 140 were in the direct LOS to the SSR 110. The ownship 140 may be equipped with Global Positioning System (GPS) or ADS-B Out functionality for determining its own position.

The interrogation time at the SSR is determined as:

Tx_1030=Tr_1090−(length of the 1030 path+length of the 1090 path)/c−3 μsec

where Tx_1030 is the interrogation time at the SSR 110, and Tr_1090 is a receive time of the 1090 MHz response at the PSSR 190 from the transponder of the opportunistic aircraft 115, and c is the speed of light. A delay of 3 μsec, which is a predetermined transponder response time, is added to account for the fixed dwell time between the opportunistic aircraft 115 receiving the 1030 MHz interrogations and issuing the 1090 MHz responses.

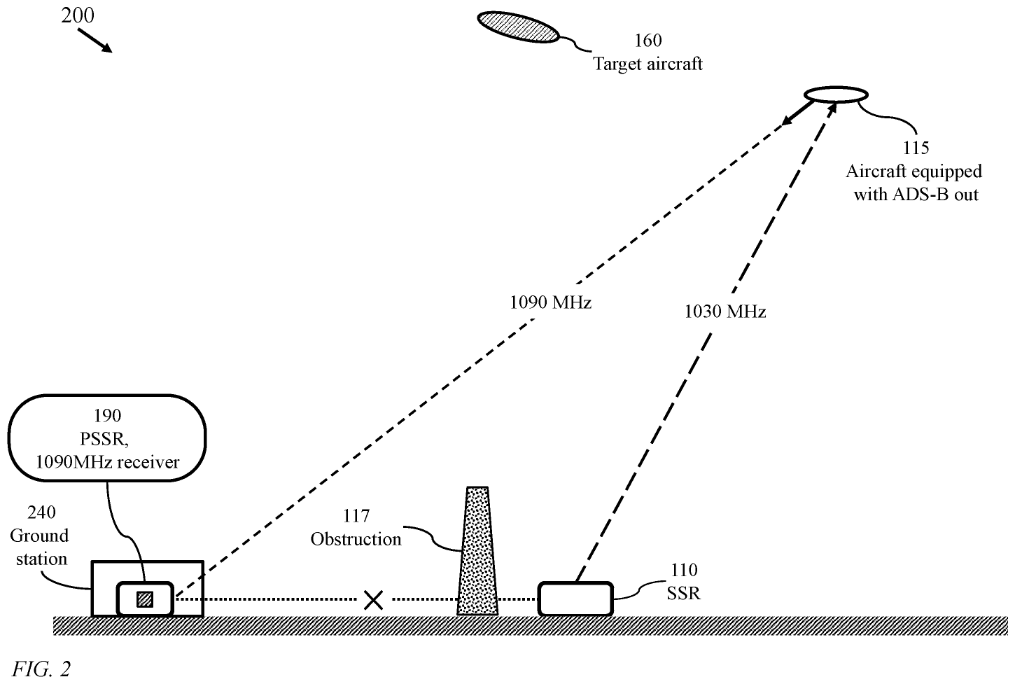

FIG. 2 illustrates a scenario 200 where a PSSR 190 in a ground station 240 and aircraft 115 are within communication range of SSR 110, however, the PSSR is unable to monitor interrogations from SSR 110 along a LOS path due to a temporary obstruction 117.

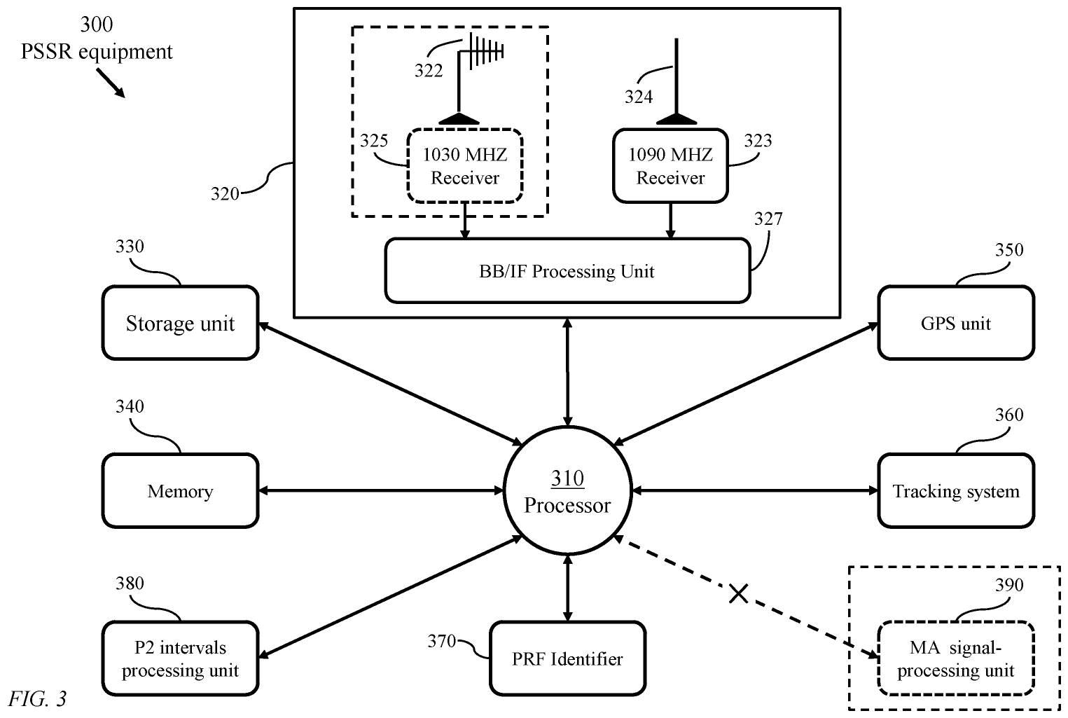

FIG. 3 illustrates equipment 300 of a mobile PSSR embedded in the ownship 140 comprising a module for identifying a pulse repetition frequency pattern (PRF pattern) of an SSR within communication reach of the mobile PSSR.

The PSSR system 300 comprises a receiver unit 320 for receiving, through an antenna system (322, 324) SSR mode C, all-call, and roll-call interrogations signals 130 comprising P1, P2 and P3 pulses and Mode A/C replies 150 from the target object 160. In a preferred embodiment, the receiver unit 320 comprises an omni-directional antenna 324 (such as a dipole). Since transponders generally use an omni-directional antenna, the ownship 140 can always receive reply messages from the target object 160. The receiver unit 320 may further comprise a directional antenna 322, for example for detection of the signals transmitted by the SSR 110 to enhance the SSR range when needed. Optionally, a multiple antenna array may be added to the receiver unit 320 to estimate the angle of arrival (AOA) of the target object 160 reply signal, which is useful for the case when the target object does not have a transponder.

The receiver unit 320 comprises a 1030 MHz receiver 325 connected to the directional antenna 322 or to the omni-directional antenna 324 through a splitter (not illustrated) for detecting the interrogation signals transmitted by the SSR through the narrow-beam antenna (P1, P3) or the SLS signal (P2 pulse) through the wide-beam antenna of the SSR 110. The 1030 MHz receiver 325 is tuned to the 1030 MHz frequency band for receiving and filtering P2 as well as P1 and P3 signals in that frequency band. The receiver unit 320 comprises also a 1090 MHz receiver 323 tuned to 1090 MHz frequency band for receiving and filtering signals around 1090 MHz through the omni-directional antenna 324 or through the directional antenna 322 through a splitter (not illustrated).

Generally, a pair of antennas, a directional antenna and an omni-directional antenna, may feed to both the 1090 MHz and 1030 MHz receivers through an additional “splitter” unit. In fact, a minimal system employs one omni antenna feeding to both the 1030 MHz and 1090 MHz receivers through a splitter. Alternatively, the directional antenna 324 and the omni-directional antenna 322 may feed to receivers 323 and 325 through a switch unit.

The 1090 MHz receiver 323 detects reply signals from target object 160 which are transmitted at the 1090 MHz frequency. Both the 1030 MHz receiver 325 and 1090 MHz receiver 323 are connected to a Baseband/Intermediary Frequency (BB/IF) processing unit 327 for receiving the signals detected by the receiver 325 and receiver 323 and converting them into a baseband or into an intermediary frequency using a local oscillator. The BB/IF processing unit 327 digitizes the received signals and pass the digitized signals along to a processor 310 for further processing. Processor 310 may be implemented as am assembly of multiple hardware processors arranged in multiple processing units.

In one embodiment processor 310 provides the processing power for performing the operations of the present invention. The processor 310 can be a micro-controller or a microprocessor or any processor device capable of executing the operations of the present invention, such processor devices are well known to those skilled in the art. The processor 310 receives digital signals from the receiver unit 320 and executes operations dictated by operating modules embedded or connected to the processor 310. In this embodiment a P2 intervals processing unit 380, along with the processor 310, process the signals corresponding to the P2 pulses for determining the time intervals between P2 Pulses received at the PSSR 300. The P2 intervals processing unit 380 creates a time-ordered sequence of P2 Pulse intervals that are stored in a memory device 340. The time-ordered sequence of P2 Pulse intervals is a sequence of intervals formed from the received P2 pulses and ordered according to the reception time of the P2 pulses. As an example, for 4 pulses received respectively at times t₀, t₁, t₂ and t₃, the time-ordered sequence of pulse intervals would be ordered as intervals I₁, I₂ and I₃ with Iₙ formed from P2 pulses received at time n and at time n−1. The P2 intervals processing unit 380 adds any new interval as well determined from a new P2 pulse and the last received P2 pulse to the time-ordered sequence of pulse intervals, and compares the new interval to the previously stored pulse intervals in the time-ordered sequence of pulse intervals. The PRF Identifier 370 based on the result of that comparison applies a procedure to identify a repeating sequence of intervals and determine the PRF pattern. The procedures applied by the P2 intervals processing unit 380 and the PRF identifier 370 have been described in detail with regard to FIG. 5A of the aforementioned U.S. patent application Ser. No. 17/577,250 (attorney docket number SEA-008-US).

In another embodiment processor 310 communicates with the SSR main antenna (MA) signal processing unit 390. The MA signal processing unit 390 identifies and decodes the Mode A/C messages that includes P1 and P3 pulses, no matter whether P2 is stronger or weaker than P1. These messages could come from the main lobe or side lobe of the MA. The main functions of the MA signal processing unit 390 include two parts: i) to determine the pattern of the interlaced Mode A/C interrogation, which is the interrogation pattern. This pattern could be ACACAC or AACAAC, etc. With the MA interrogation sequence and the interval between successive interrogations, a match of the MA pattern inside the whole stagger pattern can be found, and further to determine the type for every interrogation in the stagger pattern; ii) to determine the mechanical rotation of the MA. The procedures applied by the MA signal processing unit 390 have been described in detail with regard to FIG. 5B of the aforementioned U.S. patent application Ser. No. 17/577,250 (attorney docket number SEA-008-US).

As illustrated in FIG. 3, the PSSR 300 relies on a data storage system 330 and a memory 340 both connected to the processor 310 to store data and information necessary to its operation. Permanent or long-term data such as SSR location, PRF pattern once identified can be stored in the data storage 330 while short-term data such as time-ordered sequence of pulse intervals, cached data or other program instructions can be stored in the memory 340.

The PSSR system 300, in a preferred embodiment, comprises a Global Positioning System (GPS) unit 350 for determining the location of the ownship 140. All the information related to the position and trajectory of the ownship 140 as well as the target object 160is displayed on a display for advising the pilot of the ownship 140. In one embodiment, the display is part of a tracking system 360 that monitors the relative distance between the two objects (target object 160 and ownship 140). The tracking of the position and trajectory of the ownship 140 and target object 160 on the display provides a visual cue to the pilot of the ownship 140 to know the relative spacing between the ownship 140 and target object 160 and to take appropriate measures to mitigate any potential problem. More importantly, this allows the prediction of the target object movement based on the previous detection results and provide a confident estimation of the position of the target object even when the detection of the target object is missed in several detections. Additionally, an audio alarm system may be provided as part of the tracking system 360 to alert the pilot as well. Alternatively, the display may be standalone or shared with other components such as a computing device within the ownship 140and/or the GPS unit 350 and the tracking system 360.

In the scenarios of FIG. 1 and FIG. 2, the 1030 MHz receiver 325 does not detect interrogations from the SSR due to the obstruction, and signal-processing unit 390 is, therefore, inactive.

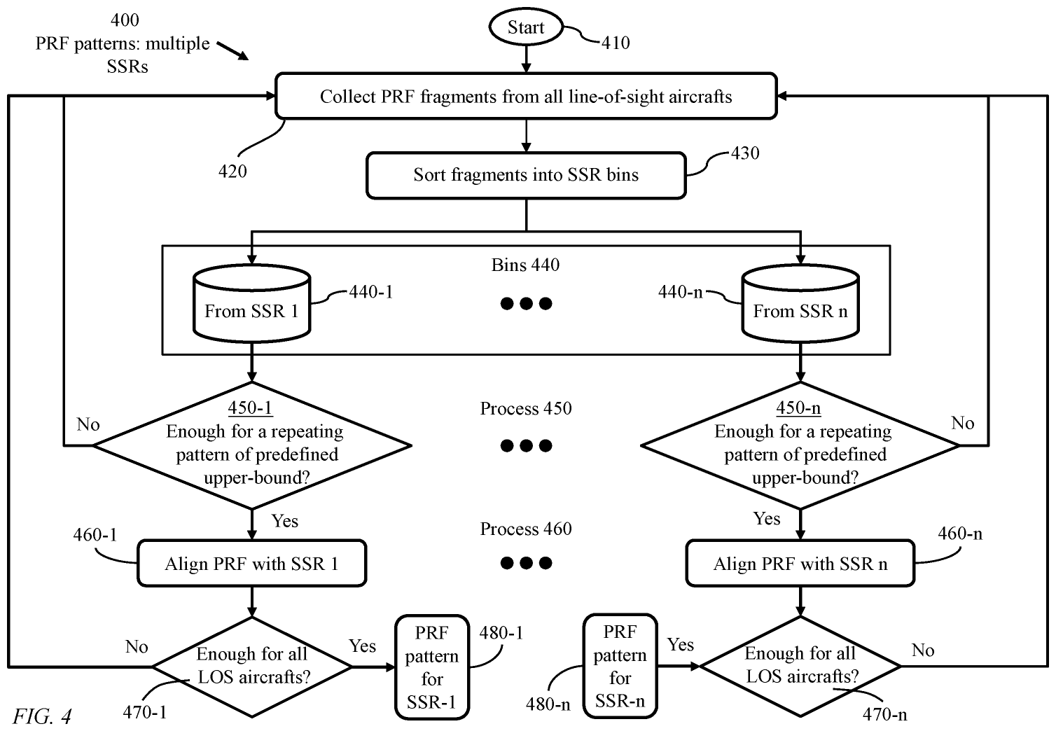

FIG. 4 illustrates a scheme 400 for determining individual PRF patterns of multiple SSRs (only SSR 110 is illustrated in FIG. 1 and FIG. 2) where each SSR has a direct communication path to aircraft 115.

Upon activation (process 410), process 420 collects PRF fragments from all LOS opportunistic aircraft. The LOS aircraft 115 is in the LOS to one or more SSR and to the ownship 140. When a LOS aircraft 115 is in the main beam of SSR 110 (FIG. 1), it is interrogated, for example m times, where m is typically around 6-7 and is usually less than the full length of the PRF pattern which is typically ≥16 interrogations. Hence, the ownship aircraft 140 will see only a fragment of the full PRF interrogation pattern.

It is understood that instead of collecting fragments of the PRF interrogation pattern from interrogations by the main beam of the SSR 110, it is also possible to detect side lobe suppression pulses P2 of the staggered interrogation signal from a Side Lobe Suppression (SLS) omni directional beam of the SSR 110, when the opportunistic aircraft is within a beam-width of the omni directional antenna, as described in U.S. patent application Ser. No. 17/577,250, AVIATION DETECT AND AVOID METHOD AND SYSTEM, cited above.

Process 430 places collected fragments into bins 440, each bin corresponding to a respective SSR. The individual bins are labelled 440-1 to 440-n, n being the number of SSR.

The methods described below apply uniformly for situations where more than one aircraft, each equipped with an “ADS-B-out” or “ADS-B UAT out” device, are within communication range of SSR 110 (only one such aircraft 115 is illustrated in FIG. 1 and FIG. 2).

Different SSR would be communicating to aircraft 115 at different times because of their different spinning speeds and will result in different bearings at each instant of time. Hence the collected fragments of PRFs may be sorted according to the rotational patterns of the one or more SSR.

The 1090 MHz responses from different LOS aircraft 115 may be additionally or alternatively sorted, because each LOS aircraft 115 may have different squawk codes in their Mode A transponder responses and different altitudes from their Mode C transponder responses.

The altitudes may be also correlated with reported altitudes in their ADS-B messages. Moreover, the transponder carrier frequency in each LOS aircraft 115 would have slightly different frequency variations from the mandated 1090 MHz and would also have their unique phases from the local oscillator for the carrier frequency.

The signal strengths from different LOS aircraft 115 would also be different because of different 1090 MHz path lengths.

These differences may be used to sort the fragments according to respective SSR.

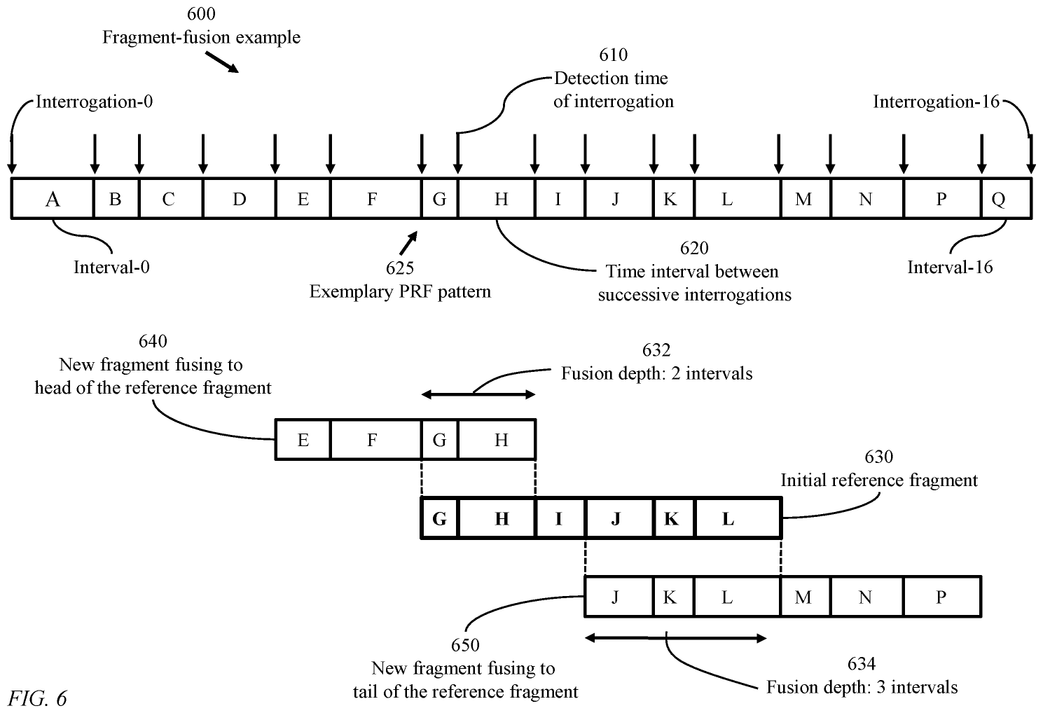

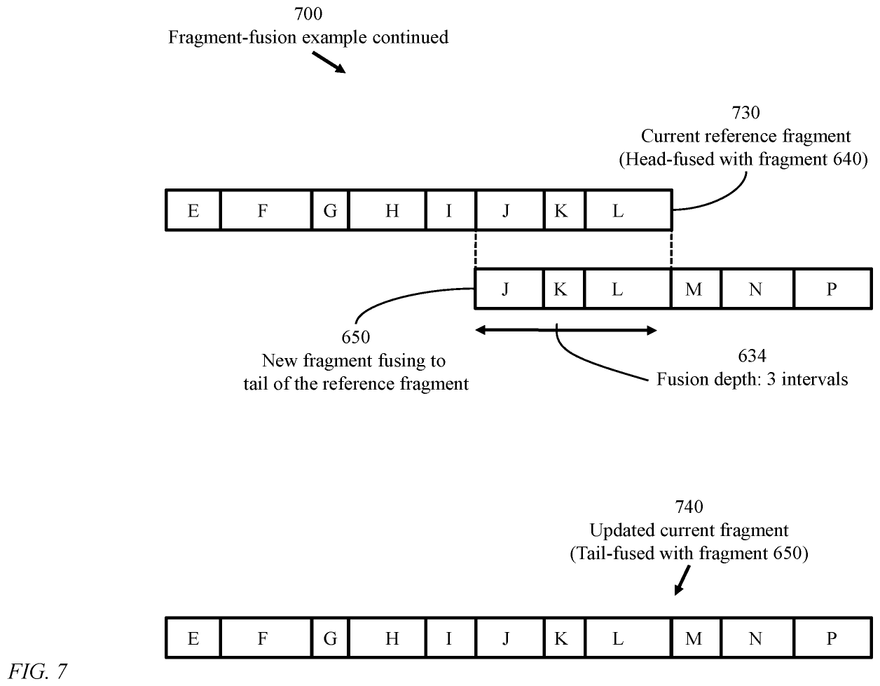

Processes 450 (individually 450-1 to 450-n) determine the respective PRF patterns by fusing respective PRF fragments together to form longer strings to synthesize a complete PRF pattern that is repeated. A first method (first algorithm) is illustrated in FIG. 5, FIG. 6, and FIG. 7.

Once a corresponding repeating pattern is found for a respective SSR, Processes 460 (individually 460-1 to 460-n) align the timings of the PRF interrogations with the SSR transmitting times using ADS-B aircraft 115 (or any other opportunistic air craft) having a direct communication path to SSR 110 (or any other SSR for the case of multiple SSR described above) and a direct communication path to the ownship aircraft 140, since the lengths of the 1030 and 1090 paths are known. This process can be repeated from time to time to correct for possible time-drifts of the profiled PRF pattern of the SSR 110.

Once the repeating PRF pattern is found and aligned with the respective SSR, the ownship aircraft 140 can use the PRF pattern of a profiled SSR to validate all the reported GPS positions of the LOS ADS-B aircraft. If there are 1090 MHz responses from aircraft 115 that do not consistently match the PRF pattern, then what is detected is only a fragment of the full PRF pattern of this SSR. Accordingly, a longer repeating PRF sequence needs to be found. If the detected fragments are insufficient to synthesize full PRF patterns, process 420 is revisited to collect more fragments (processes 470-1 to 470-n).

Scheme 400 concludes with finding corresponding PRF patterns for corresponding SSR (outputs 480-1 to 480-n).

FIG. 5 illustrates a first method 500 of synthesizing a PRF pattern from detected fragments of the PRF pattern. Process 510 selects a fragment from a specific bin 440 corresponding o a specific SSR (one of bins 440-1 to 440-n, n being a number of SSR within a direct or indirect communication reach, n>=1). The selected fragment is referenced as a string to be augmented through fusing other fragments to get a longer string finally leading to a complete PRF pattern. Fusing of fragments is illustrated in FIG. 6 and FIG. 7.

Process 520 fuses fragments that overlap the (growing) string either to the start of the string (Head fusing) or the end of the string (Tail fusing). A “depth of fusing” is defined as the number of common intervals of two fragments to be fused or the number of common intervals of a fragment and an already enlarged string. As illustrated in FIG. 6, the depth of fusing of fragments 630 and 640 is two intervals (reference 632). If it is decided to fuse fragments 630 and 650, the depth of fusing would be three intervals (reference 634). As illustrated in FIG. 7, the depth of fusing fragment 650 to string 730 is three intervals (which are intervals {J, K, L}).

In addition, fusing requires that the modes of the interrogations also match: If two intervals of a first fragment are sandwiched by a Mode A, a Mode C and then a Mode A interrogation sequence, then candidate intervals, based on intervals durations, of a second fragment should also be sandwiched between the same modes A-C-A interrogation sequence.

Process 530 determines if, so far, the growing string comprises at least a predefined number of intervals. If the string length does not meet the requirement, process 540 revisits process 520 to acquire more fragments. If the string comprises a number of intervals equal to, or exceeding, the predefined number, process 550 is activated to determine if, so far, the string comprises at least two repeating parts (repeating substrings).

If repeating parts cannot be ascertained, process 560 presents the string to process 520 to fuse more fragments. Otherwise, if the string comprises at least two repeating parts, process 570 sets the repeating part as the PRF of the specific SSR.

FIG. 6 illustrates an example 600 of head-fusing of two fragments into a string and tail-fusing of two fragments to produce strings for further fusing with other fragments. Considering a case where an PRF pattern comprises sixteen time-intervals (also referenced as “intervals”) 620 corresponding to seventeen SSR interrogations 610. The durations of the intervals are distinctly different and the sequence of the unequal intervals is SSR-specific, differing from one SSR to another. The unequal intervals are labelled as “A to Q”.

In the illustrated example, a fragment 630 is initially selected in process 510. The initial fragment 630 comprises six intervals {G, H, I, J, K, L}. The initial fragment forms astringto be grown to a PRF pattern. Generally, detected fragments may be of different lengths (comprising different numbers of intervals).

Subsequently, a new fragment 640 comprising four intervals {E, F, G, H} is detected. Since the two fragments intersect in more than one interval, the two fragments can be fused to enlarge the string to contain eight intervals {E, F, G, H, I, J, K, L} as illustrated in FIG. 7. This is a process of “head-fusing” of fragment 640 to fragment 630.

Further, a fragment 650 comprising six intervals {I, J, K, L, M, P} is detected. Fragment 650 may then be tail-fused to the enlarged string {E, F, G, H, I, J, K, L}to form a further enlarged string of eleven intervals {E, F, G, H, I, J, K, L, M, N, P}. The process continues in this fashion until a complete PRF pattern is formed. To ensure that a complete PRF pattern has been synthesized, fusing of new detected fragments would continue until the string contains at least two identical parts.

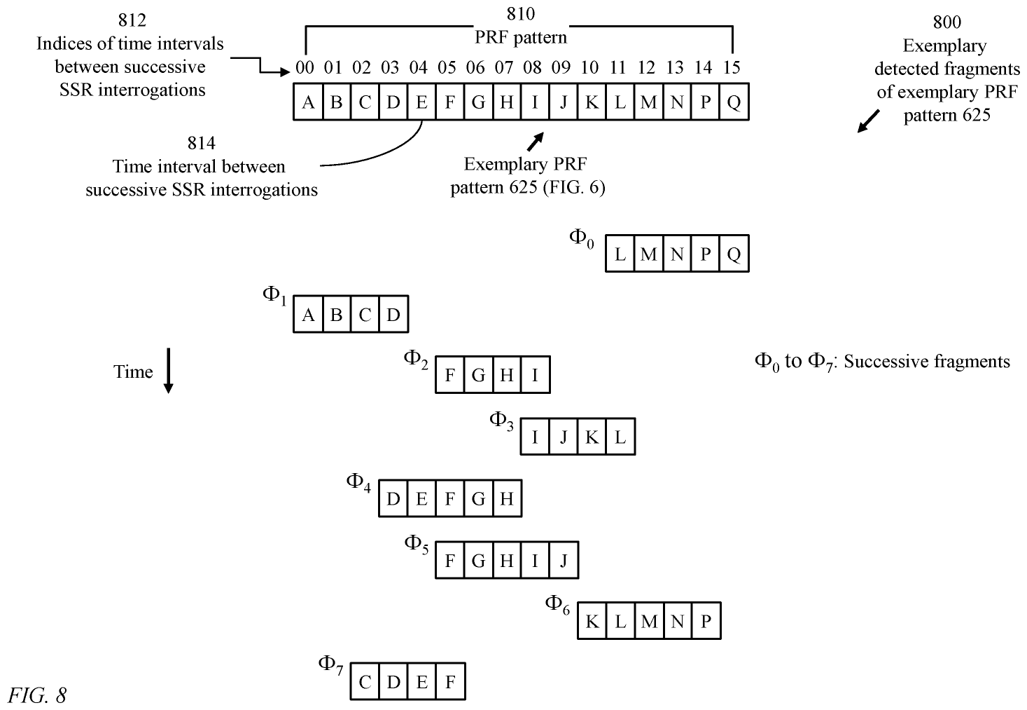

FIG. 8 illustrates an example 800 of detected fragments of exemplary PRF pattern 625 of FIG. 6. Eight fragments, denoted Φ₀ to Φ₇, are successively detected at the PSSR of ownship 140. Due to variation of the communication path from the SSR 110 to the ownship 140, whether the communication path is direct along a line-of-sight or indirect through an opportunistic air craft 115, the fragments of cyclic PRF patterns occupy random intra-PRF-pattern positions, as illustrated in FIG. 8. A pair of fragments may be:
(1) disjoint (such as Φ₁ and Φ₂ or Φ₆ and Φ₇);
(2) partially or fully congruent where the intervals of one fragment constitute a subset of the intervals of the other fragment, or are identical to the intervals of the other fragment, for example a fragment containing intervals {L, M, N, P} or a fragment containing intervals {M, N, P, Q} would be partially congruent with fragment Φ₀, i.e., embedded in Φ₀, also, a pair of fragments may be fully congruent if the fragments are of equal lengths, occupying the same intra-PRF-pattern position in different cycles of the PRF pattern (as indicated in the algorithm of method-2 of FIG. 9, a new fragment that is partially or fully congruent with a previous fragment is discarded); and
(3) edge-intersecting so that the union of the two fragments comprises more intervals than either of the two fragments, for example fragments Φ₄ and Φ₅ are edge intersecting, and fragments Φ₄ and Φ₇ are edge intersecting, also a fragment containing intervals {P, Q, A, B), which traverses two successive PRF patterns would be edge intersecting with Φ₀ and edge intersecting with Φ₁.

FIG. 9 illustrates a second method 900 of synthesizing a PRF pattern of a specific SSR from detected fragments of the PRF pattern, the second method expedites the synthesis process and enables synthesis of multiple PRF patterns.

Process 910 initializes an array of records as an empty array including only one null record.

Process 920 detects a set of successive interrogations (FIG. 6) and determines a respective new fragment of successive inter-interrogation time intervals 620.

Process 930 attempts fusing the new fragment with a selected record of the array of records to produce an extended record called “a primary extended record” since the produced extended record may fuse with another record in the array of records. Initially, the array of records is empty, hence the extended record contains the first detected fragment.

Process 940 determines whether the new record is embedded within any record of the array of records. If so, the new fragment does not provide any new information and is discarded and process 920 is revisited to detect another fragment. Naturally, the first fragment would not be embedded in any record.

If the new record is not embedded in another record, process 950 determines whether the new fragment is disjoint from all records formed so far, i.e., there is no fusing opportunity, or the new fragment head-fused or tail fused with any record in the array of records. If the new fragment is disjoint, process 955 inserts the new fragment in the array of records as a new record then revisits process 920 to detect another fragment.

If the new fragment fuses to any record to produce a primary extended record, process 960 attempts fusing the primary extended record with any other record of the array of records to produce a secondary extended record.

If process 960 does not produce a secondary extended record, process 970 instructs process 975 to update the selected record of process 930 to be the primary extended record.

If process 960 produces a secondary extended record, process 970 instructs process 980 to delete the other record that fused with the primary extended record, then process 985 updates the selected record of process 930 to be the secondary extended record.

Each of processes 975 and 985 leads to process 990 which overwrites the selected record of process 930 with the updated record (which is either the primary extended record or the secondary extended record).

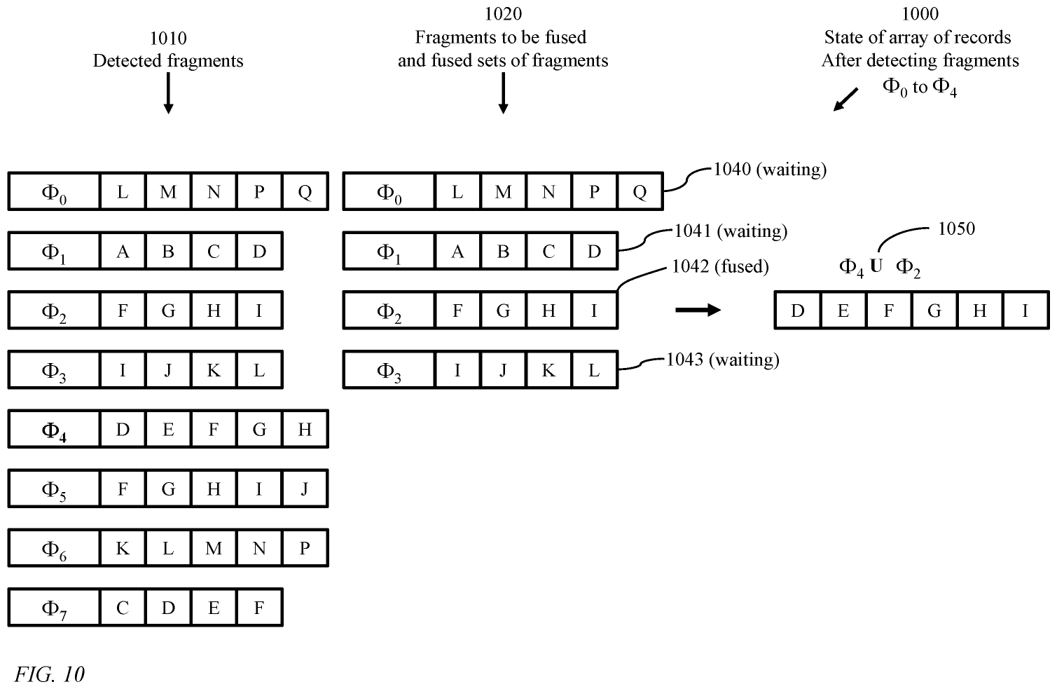

FIG. 10 illustrates process 1000 of updating the array of records after detecting fragments Φ₀ to Φ₄, as a result of application of the method of FIG. 9 to synthesize a PRF pattern from the detected fragments of FIG. 8. The sequence of eight forthcoming detected fragments is listed, reference 1010, forthcoming contents of the array of records are also listed, reference 1020, for ease of reference.

The first detected fragment, in process 920, is fragment Φ₀. Since the array of records is empty when the first fragment is received, process 930 fuses fragment Φ₀ with the null record to produce a primary extended record comprising only fragment Φ₀. Processes 940 determines that new fragment Φ₀ is not embedded in any record since the array of records is so far empty. Process 950 determines that fusing is successful since a primary extended record containing fragment Φ₀ has been produced in process 930. Process 960 cannot fuse the primary extended record with another record since the array of record is empty. Thus, process 970 instructs process 975 to produce an “updated record” containing the primary extended record which contains fragment Φ₀ only. Process 990 replaces the null record of the array of records with the primary extended record as the first record 1040, which contains fragment Φ₀ only, then revisits process 920.

Process 920 then detects fragment Φ₁. Process 930 cannot fuse fragment Φ₁ with the only record of the array of records which contains fragment Φ₀ only since fragments Φ₁ and Φ₀ do not intersect. Process 940 determines that the new fragment Φ₁ is not embedded in the record in the array of records. Process 950 determines that fragment Φ₁ did not fuse with the current record of the array of records. Hence, process 955 inserts fragment Φ₁ as a second record 1041 in the array of records and revisits process 920 to detect another fragment.

Process 920 then detects fragment Φ₂. Process 930 cannot fuse fragment Φ₂ with either of the two records of the array of records, containing only fragments Φ₀ and Φ₁, since fragment Φ₂ does not intersect either of fragments Φ₀ and Φ₁. Process 940 determines that the new fragment Φ₂ is not embedded in either of the two records of the array of records record. Process 950 determines that fragment Φ₂ did not fuse with the current records of the array of records. Hence, process 955 inserts fragment Φ₂ as a third record 1042 in the array of records and revisits process 920 to detect another fragment.

Process 920 then detects fragment Φ₃. Process 930 cannot fuse fragment Φ₃ with any of the three records of the array of records, containing only fragments Φ₀, Φ₁, and Φ₂, since fragment Φ₃ does not intersect either of fragments Φ₀ and Φ₁ and has an edge intersection of only depth 1 (only one interval in common) with fragment Φ₂. Process 940 determines that the new fragment Φ₃ is not embedded in any of the three records of the array of records. Process 950 determines that fragment Φ₃ did not fuse with the current records of the array of records. Hence, process 955 inserts fragment Φ₃ as a fourth record 1043 in the array of records and revisits process 920 to detect another fragment.

Process 920 then detects fragment Φ₄. Process 930 determines that fragment Φ₄ has an edge intersection of depth 3 (having three intervals {F, G, H} in common) with fragment Φ₂ which is the content of the third record of the array of records. Thus, the third record which contains fragment Φ₂, is the selected record and process 930 produces a primary extended record 1050 as the union (Φ₄UΦ₂).

Process 940 determines that the new fragment Φ₄ is not embedded in any of the four records of the array of records. Process 950 determines that fragment Φ₄ successfully fused with the selected record (the third record). Hence, process 960 attempts to fuse the primary extended record 1050 with any of the records of the array of records, other than the already fused third record 1042. However, none of the first, second or fourth records containing fragments Φ₀, Φ₁ and Φ₃, has an edge intersection of sufficient depth (greater than 1) to permit fusing. Thus, process 970 determines that secondary fusing is not feasible and then instructs process 975 to produce an updated record as the primary extended record 1050. Process 990 overwrites the third record, containing only fragment Φ₂, to contain the updated record, which is the primary extended record 1050, also referenced as string 1050.

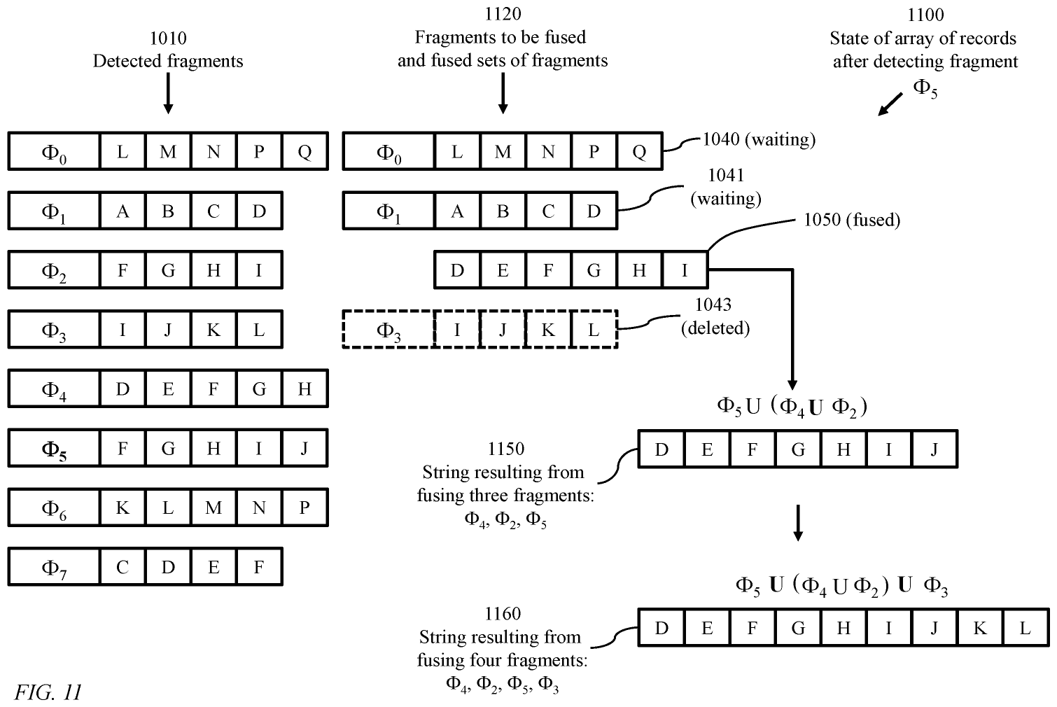

FIG. 11 illustrates process 1100 of updating the array of records after detecting fragment Φ5, as a result of application of the method of FIG. 9.

Process 920 detects fragment Φ₅. Process 930 determines that fragment Φ₅ has an edge intersection of depth 4 with string 1050 of the third record of the array of records (having four intervals {F, G, H, I} in common). Thus, the third record which contains string 1050 is the selected record and process 930 produces a primary extended record 1150 as the union (Φ₅U(Φ₄UΦ₂)). Thus, string 1050 {D, E, F, G, H, I} is updated string 1150 {D, E, F, G, H, I, J}.

Process 940 determines that the new fragment Φ₅ is not embedded in any of the records of the array of records. Process 950 determines that fragment Φ₅ successfully fused with the selected record (the third record which is still containing string 1050). Hence, process 960 attempts to fuse string 1150 with any of the records of the array of records, other than the already fused third record 1042. Neither the first record nor the second record, containing fragments Φ₀ and Φ₁, respectively, has an edge intersection of sufficient depth to permit fusing. The fourth record containing fragment Φ₃ has an edge intersection of depth 2 with string 1150 residing in the third record of the array of records (having two common intervals {I, J}). Thus, process 960 fuses the fourth record containing fragment Φ₃ to string 1150 to produce string 1160 {D, E, F, G, H, I, J, K, L} which is the union((Φ₅U(Φ₄UΦ₂))UΦ₃).

Process 970 then instructs process 980 to remove the fourth record from the array of records, since it has been fused. Process 980 produces an updated record as the new string 1160 and process 990 overwrites the third record, containing string 1050 to contain the updated record, which is string 1160. The array of records now contains records 1120 holding fragment Φ₀, fragment Φ₁, and string 1160.

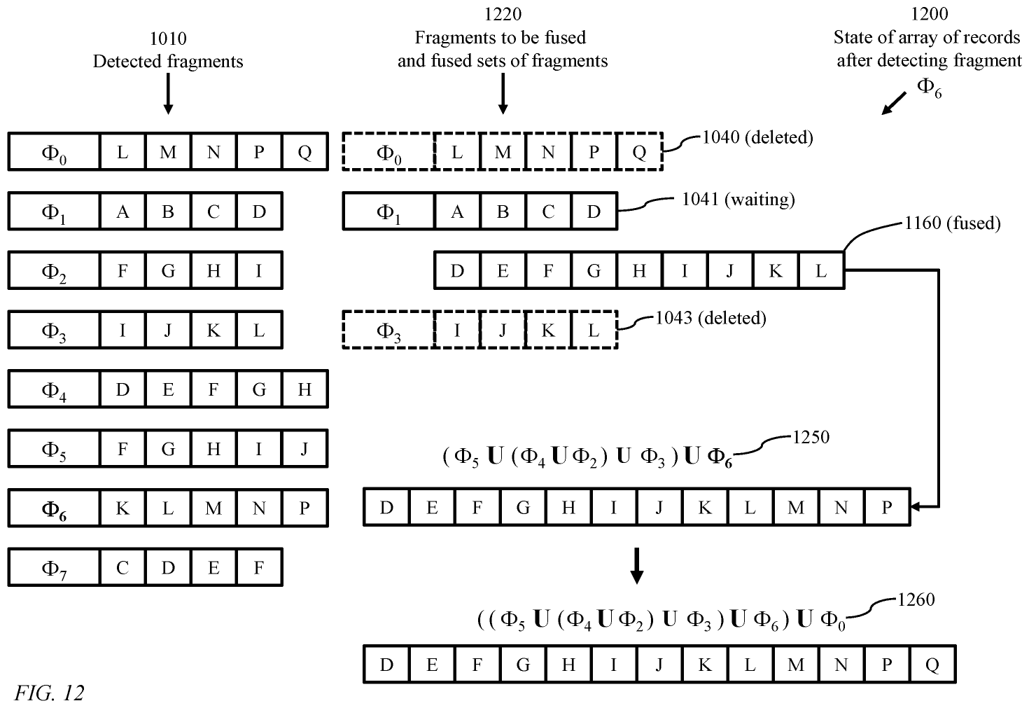

FIG. 12 illustrates process 1200 of updating the array of records after detecting fragment Φ6, as a result of application of the method of FIG. 9.

Process 920 detects fragment Φ₆. Process 930 determines that fragment Φ₆ has an edge intersection of depth 2 with string 1160 residing in the third record of the array of records (having two intervals {K, L} in common). Thus, the third record which contains string 1160 is the selected record and process 930 produces a primary extended record 1250 as the union (((Φ₅U(Φ₄UΦ₂))UΦ₃)UΦ₆). Thus, string 1160 {D, E, F, G, H, I, J, K, L} is updated to string 1250 {D, E, F, G, H, I, J, K, L, M, N, P}.

Process 940 determines that the new fragment Φ₆ is not embedded in any of the records of the array of records. Process 950 determines that fragment Φ₆ successfully fused with the selected record (the third record now still containing string 1160). Hence, process 960 attempts to fuse string 1250 with any of the records of the array of records that are not deleted (marked as still waiting).

The first record containing fragment Φ₀ has an edge intersection of depth 4 with string 1250 (having four common intervals {L,M,N,P}. Thus, process 960 fuses the first record containing fragment Φ₀ to string 1250 to produce string 1260 {D, E, F, G, H, I, J, K, L, M, N, P,Q} which is the union((((Φ₅U(Φ₄UΦ₂))UΦ₃)UΦ₆)UΦ₀).

Process 970 then instructs process 980 to remove the first record from the array of records, since it has been fused. Process 980 produces an updated record as the new string 1260 and process 990 overwrites the third record, containing string 1160 to contain the updated record, which is string 1260. The array of records now contains records 1220 holding fragment Φ₁ and string 1260.

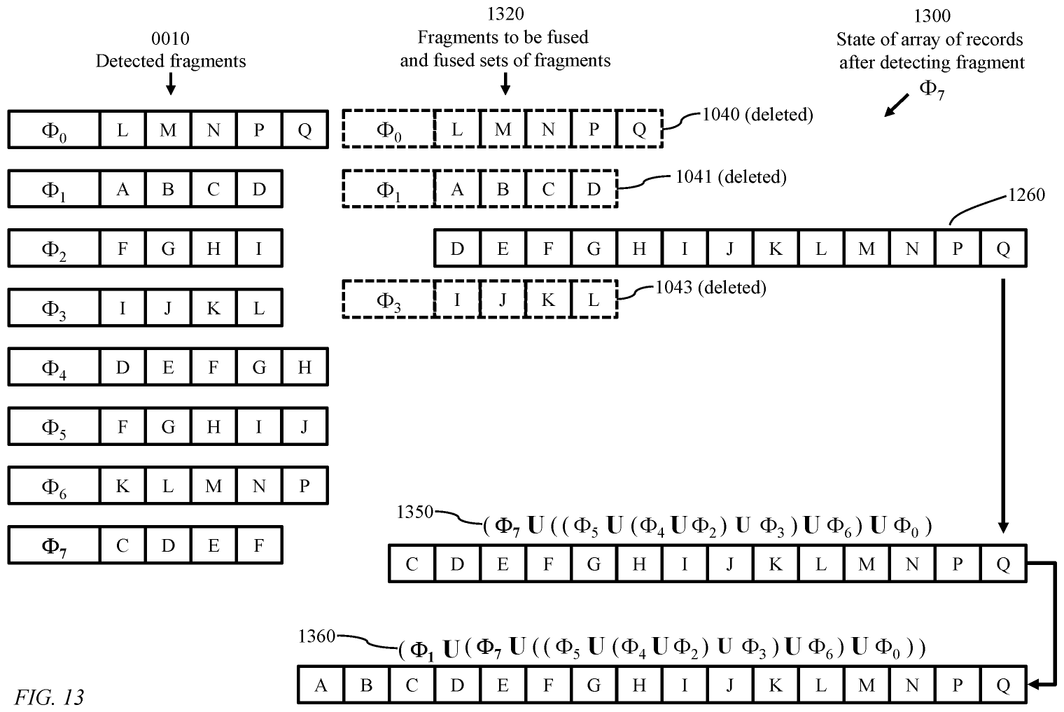

FIG. 13 illustrates the state 1300 of the array of records after detecting fragment Φ7, as a result of application of the method of FIG. 9.

Process 920 detects fragment Φ₇. Process 930 determines that fragment Φ₇ has an edge intersection of depth 3 with string 1260 residing in the third record of the array of records (having three intervals {D,E,F} in common). Thus, the third record which contains string 1260₂ is the selected record and process 930 produces a primary extended record 1350 as the union (Φ₇U((((Φ₅U(Φ₄UΦ₂))UΦ₃)UΦ₆)UΦ₀)). Thus, string 1260 {D, E, F, G, H, I, J, K, L, M, N, P, Q} is updated to string 1350 {C, D, E, F, G, H, I, J, K, L, M, N, P, Q}.

Process 940 determines that the new fragment Φ₇ is not embedded in any of the records of the array of records. Process 950 determines that fragment Φ₇ successfully fused with the selected record (the third record now still containing string 1260). Hence, process 960 attempts to fuse string 1350 with any of the records of the array of records that are not deleted (marked as waiting). The second record containing fragment Φ₁, which is still waiting has an edge intersection of sufficient depth to permit fusing with string 1350. The first and fourth records have been deleted. The second record containing fragment Φ₁ has an edge intersection of depth 2 with string 1350 (having two common intervals {C, D}). Thus, process 960 fuses the second record containing fragment Φ₁ to string 1350 to produce string 1360 {A, B, C, D, E, F, G, H, I, J, K, L, M, N, P, Q} which is the union((((Φ₅U(Φ₄UΦ₂))UΦ₃)UΦ₆)UΦ₀).

Process 970 then instructs process 980 to remove the second record from the array of records, since it has been fused. Process 980 produces an updated record as the new string 1360 and process 990 overwrites the third record, containing string 1260 to contain the updated record, which is string 1360. The array of records now contains record 1320 holding only string 1360.

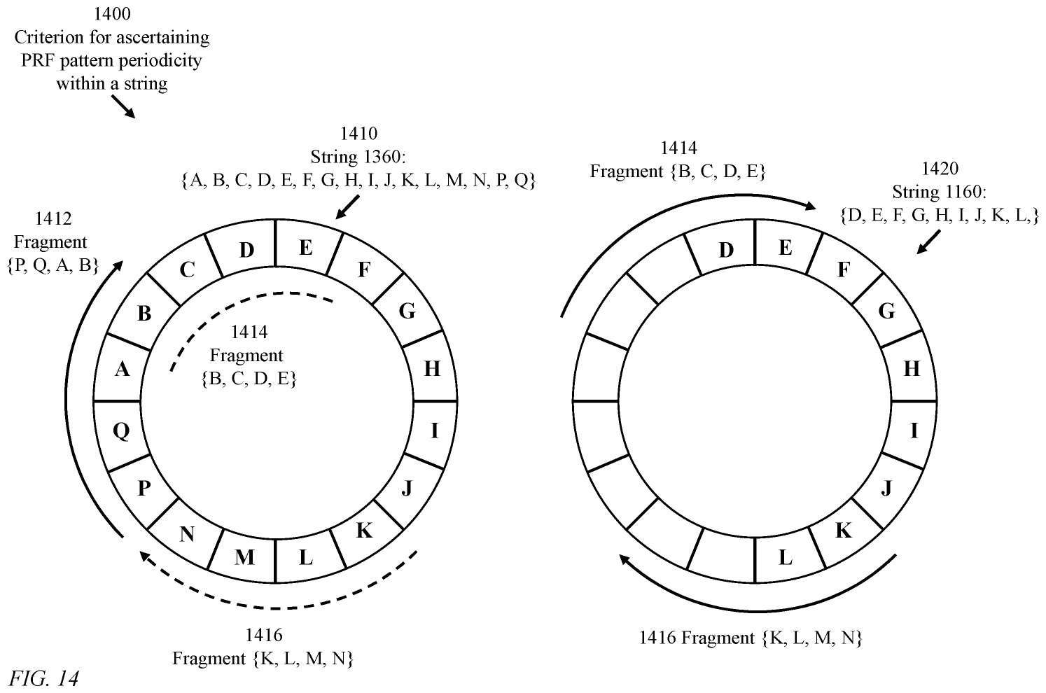

FIG. 14 illustrates a criterion 1400 for verifying PRF-pattern periodicity within a string. Consider string 1360 of FIG. 13 and string 1160 of FIG. 11. String 1360 comprises intervals {A,B,C,D,E,F,G,H,I,J,K,L,M,N,P,Q} while string 1160 comprises intervals {D,E,F,G,H,I,J,K,L}. Following formation of string 1160, a new fragment {F,G,H,I}, for example, which is not illustrated in FIG. 14, is detected. Since the fragment is embedded in string 1160, the fragment is discarded. Subsequently a fragment {B,C,D,E} is detected. This fragment can be head-fused to string 1160 as indicated with a fusing depth of 2. However, the fragment {B,C,D,E} cannot tail fuse to string 1160. Hence, string 1160 definitely does not constitute a complete PRF pattern. Further, a fragment {K,L,M,N} is detected. The fragment can tail-fuse to string 1160 but cannot head-fuse to string 1160. This is expected since it has just been determined that string 1160 does not constitute a complete PRF pattern.

Following formation of string 1360, a new fragment {K,L,M,N,P}, for example, is detected. Since the fragment is embedded in string 1360, the fragment is discarded. Subsequently a fragment {P,Q,A,B} is detected. This fragment can be head-fused to string 1360 or tail-fused to string 1360. This is a necessary condition for a string to be a complete cyclic PRF pattern.

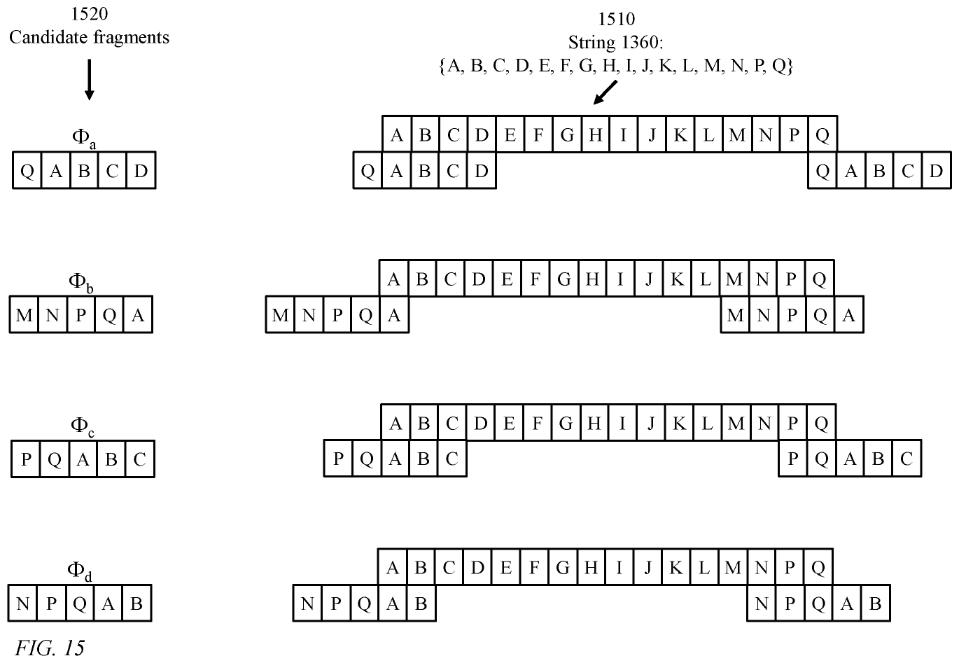

FIG. 15 illustrates four fragments, denoted Φₐ, Φ_{b}, Φ_{c}, and Φ_{d}, each of which can be head-fused or tail-fused to string 1360. If, after formation of string 1360, each detected fragment is either embedded in the string or eligible for both head-fusing and tail-fusing to the string, then the string is a complete PRF pattern, provided that the sought pattern does not contain inner sub-cycles.

### Fragments Detected from Interrogations from Multiple SSR

As illustrated in FIG. 10 to FIG. 13, based on method-2 of FIG. 9, a fragment that does not instantly fuse with previous fragments of the same SSR source is held as a “waiting” fragment in the array of records. A record containing a waiting fragment is removed from the array of records only when consumed in secondary fusing process 960. The removed records are marked in FIG. 11, FIG. 12, and FIG. 13 as “deleted”. If the fragments belong to one SSR, which is the illustrated case, then all records, except the one the contains the synthesized PRF pattern, are eventually marked as “deleted”. If the detected fragments belong to two SSRs, then one record will contain the synthesized PRF pattern of one of the two SSRs, all records that contained fragments of the profiled will be deleted, and all records containing fragments belonging to the other SSR will be present (in a “waiting” state) in the array of records. Method-2 may then be applied to the waiting records to synthesize a respective PRF pattern. The procedure can be extended to cover more than two SSRs.

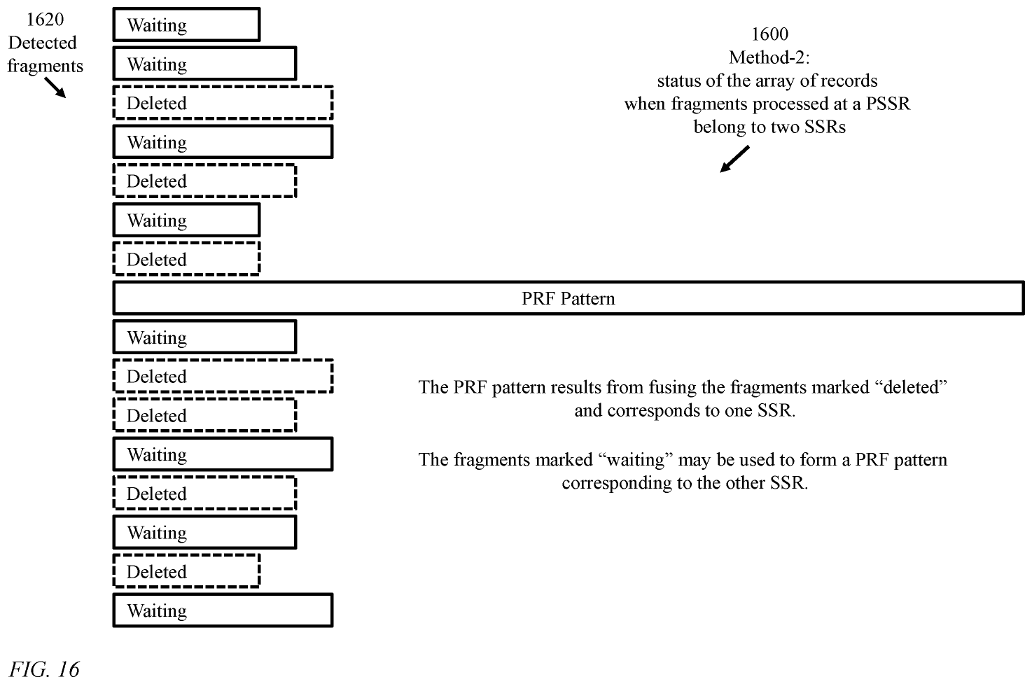

FIG. 16 illustrates an outcome 1600 of an application of the method of FIG. 9 to the case of two SSRs outlined above. The records marked “waiting” are actually the only records remaining in the array of records in addition to the synthesized PRF pattern. Since detected fragments of two distinct PRF patterns have been processed, the outcome enables synthesizing the two distinct PRF patterns.

### Positioning a Target Air Craft

FIG. 17 illustrates a scenario 1700 similar to that of FIG. 1 with the target aircraft 160 appearing within communication range of both SSR 110 and the ownship 140. The PSSR is configured to determine the spatial position of the target aircraft 160, the target aircraft being transponder equipped and receiving direct interrogation signals from the SSR 110.

Once the PRF pattern of the SSR 110 has been determined based on responses of the opportunistic aircraft 115, which is equipped with “ADS-B Out” functionality, the spatial position of the target aircraft 160, having a functioning transponder, may be determined using a method described in U.S. patent application Ser. No. 17/577,250 AVIATION DETECT AND AVOID METHOD AND SYSTEM cited above.

A reply from the target aircraft 160 is received in response to an interrogation signal sent by SSR 110 to the target aircraft 160, followed by estimating a transmit time of the interrogation signal based on a reception time of the reply and the PRF pattern. The position of the target object is based on:
an altitude value, h, of the target object contained in the reply,
the location of the SSR,
the estimated transmit time of the interrogation signal, and
the reception time of the reply.

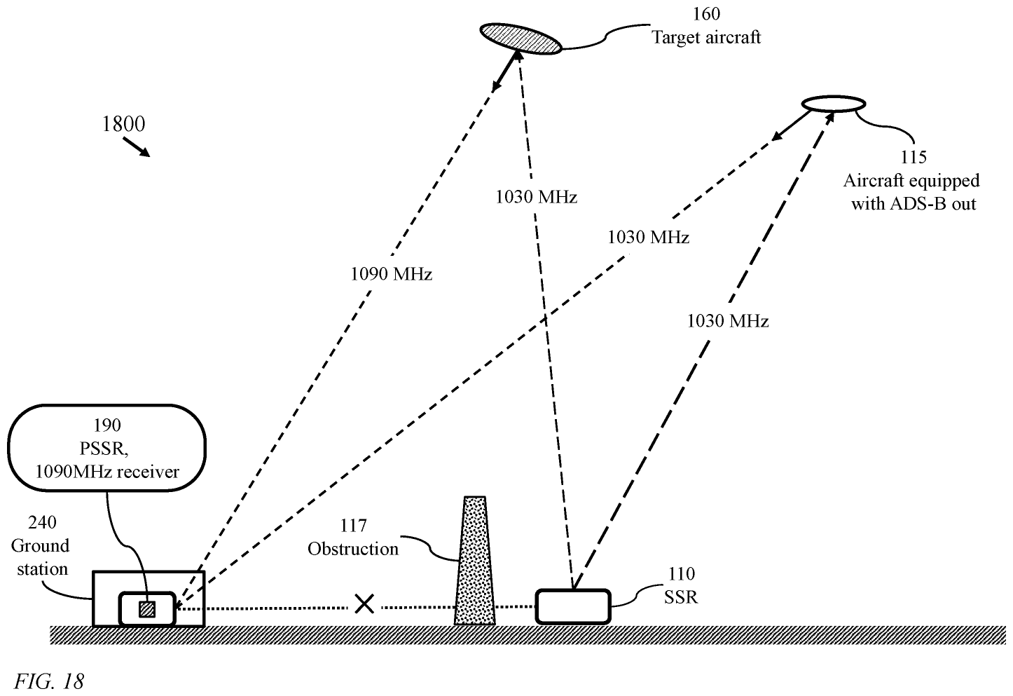

FIG. 18 illustrates a scenario 1800 similar to that of FIG. 2 with the target aircraft 160 appearing within range of the SSR and the ownship. The PSSR housed in the ground station 240 determines the spatial position of the target aircraft 160 in a manner similar to that described above for the onboard PSSR of ownship 140. Profiling the SSR Using 1090 MHz Responses from the Ownship

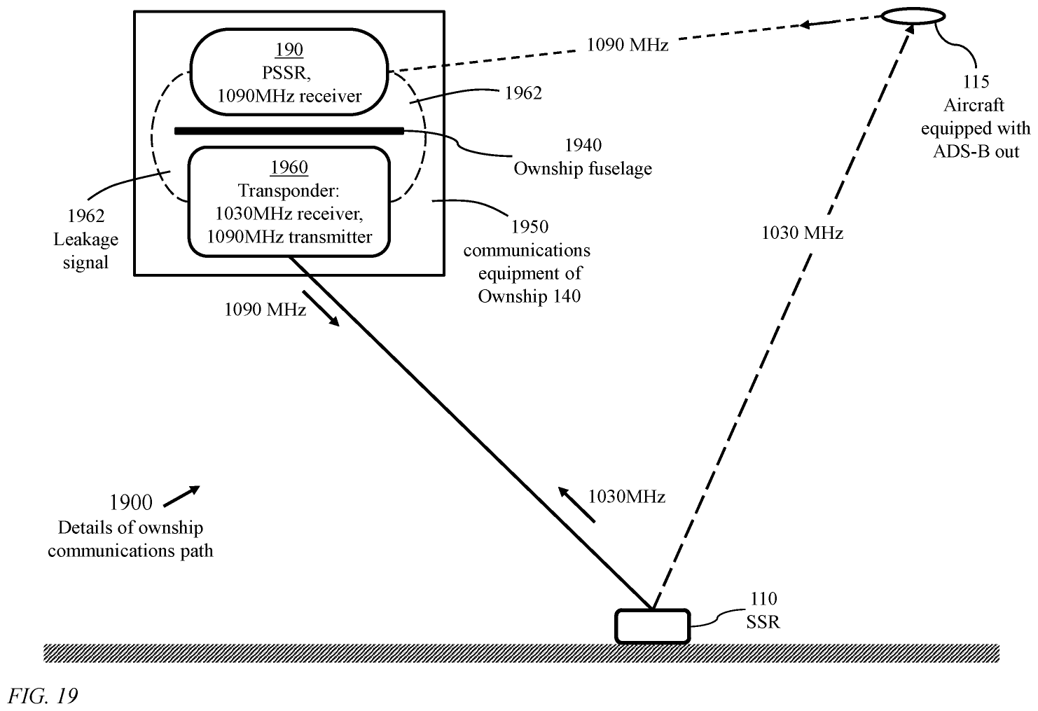

FIG. 19 illustrates a scenario 1900 similar to the scenario of FIG. 1 except for absence of obstruction 117 blocking LOS transmission from the SSR 110 to the ownship 140. SSR 110 and the ownship 140 are in direct LOS communication.

The Ownship 140 is equipped with a transponder and a PSSR 190. The PSSR may be equipped with a 1030 MHz receiver and a 1090 MHz receiver. However, the interrogation signals from the SSR, at 1030 MHz, may not be of sufficient power for detection at the onboard PSSR due to positioning the PSSR above the fuselage of the aircraft. Thus, the PSSR is limited to receiving 1090 MHz signals. The Ownship 140 is also equipped with a Global Positioning System (GPS) which enables the Ownship 140 to know its own position; alternatively, the Ownship 140 may be equipped with an ADS-B out device.

When the Ownship 140 is interrogated by SSR 110 at 1030 MHz, it transmits a response at 1090 MHz after 3 μsec. Hence the PSSR 190 knows the arrival time of the 1030 MHz interrogations by subtracting 3 μsec from the monitored 1090 MHz transmission time (Tx_1090) from the transponder at the ownship 140 as indicated with leakage paths 1962.

The PSSR 190 knows the position of the Ownship 140 from a built-in GPS or by decoding the ADS-B out message if the Ownship is equipped with an ADS-B Out device. The PSSR 190 also knows the position of the SSR 110 from its database.

For a case of a PSSR 190 capable of receiving the 1030 MHz interrogations, and is equipped with a dual-frequency (1030 MHz and 1090 MHz) receiver onboard, the time instants of receiving interrogation from an SSR is directly determined.

For the case where interrogation signals at 1030 MHz cannot be detected at PSSR 190, the PSSR can compute the transmission time Tx_1030 of the 1030 MHz interrogation from the SSR 110 as:

Tx_1030=Tx_1090−(length of the 1030 path/c)−3 μsec.

The bearing of the main beam and the mechanical spinning speed of the SSR 110 can also be determined by monitoring the same Tx_1090 responses by estimating the centre of the main beam from a sequence of m Tx_1090 responses:

T_{c}=(T|1−Tₘ)/2

where T_{c} is the timing of the center of the main beam pointing at the Ownship 140, and T₁ and Tₘ are the times of the first and last Tx_1090 responses. It is noted that since the mechanical rotating speed of the SSR 110 is relatively slow, for example about 4.8 seconds per revolution, the 3 μsec dwell time between the Tx_1090 response and the Tr_1030 interrogation can be ignored.

Once the PRF of the SSR 110 is known, the SSR 110 may be used as a beacon for example, for determining a spatial position of the ownship 140, as described in detail in the SEA-006-US Ser. No. 17/730,156 “METHOD AND APPARATUS FOR DETERMINING A POSITION OF AN AIRBORNE VEHICLE USING SECONDARY SURVEILLANCE RADARS AS BEACONS” patent application cited above. Additionally, the determined position of the ownship 140 may be used for validating, e.g. for comparing the determined position of the ownship with GSP reading or ADS-B OUT data, for assuring that other position determination means are working, or for better accuracy.

Also, the PRF of the SSR 110 may be used for determining a spatial position of a target aircraft, as described in detail in SEA-008-US Ser. No. 17/577,250 “AVIATION DETECT AND AVOID METHOD AND SYSTEM” filed Jan. 17, 2022 cited above.

Thus, the invention provides improved methods and systems for indirect profiling an SSR.

Although specific embodiments of the invention have been described in detail, it should be understood that the described embodiments are intended to be illustrative and not restrictive. Various changes and modifications of the embodiments shown in the drawings and described in the specification may be made within the scope of the following claims without departing from the scope of the invention in its broader aspect. For example, the principles of the invention can be applied to other contexts such as marine or nautical and terrestrial context.

The processes described above may be computationally intensive requiring the use of multiple hardware processors. A variety of processors, such as microprocessors, digital signal processors, and gate arrays, may be employed. Generally, processor-readable media are needed and may include floppy disks, hard disks, optical disks, Flash ROMS, non-volatile ROM, and RAM.

It should be noted that methods and systems of the embodiments of the invention and data sets described above are not, in any sense, abstract or intangible. Instead, the data is necessarily presented in a digital form and stored in a physical data-storage computer-readable medium, such as an electronic memory, mass-storage device, or other physical, tangible, data-storage device and medium. Methods described herein are necessarily carried out by electronic computing systems having processors on electronically, optically or magnetically stored data, with the results of the data processing and data analysis digitally stored in one or more tangible, physical, data-storage devices and media.

1. A system for indirect profiling a Secondary Surveillance Radar (SSR), comprising:
a Passive Secondary Surveillance Radar (PSSR), the PSSR not being able to receive interrogation signals from the SSR;
an opportunistic aircraft, which is:
(i) equipped with a transponder and has an Automatic Dependent Surveillance-Broadcast (ADS-B) Out functionality;
(ii) in the Line-of-Sight (LOS) with both the SSR and the PSSR;
(iii) interrogated with the interrogation signals from the SSR, when the opportunistic aircraft is within a beam of the SSR during one or more rotations of the SSR;
the PSSR comprising:
(a) means for collecting transponder response signals from the opportunistic aircraft to said interrogation signals from the SSR during said one or more rotations of the SSR;
(b) means for receiving an ADS-B Out response from the opportunistic aircraft and decoding a spatial position of the opportunistic aircraft from the ADS-B Out response;
(c) means for determining a staggered Pulse Repetition Frequency (PRF) pattern of the SSR using the collected transponder response signals, the decoded spatial position of the opportunistic aircraft, a position of the ownship and a position of the SSR, and a predetermined transponder response time at the opportunistic aircraft.

2. The system of claim 1, wherein the interrogation signals are at 1030 MHz, and the transponder response signals are at 1090 MHz.

3. The system of claim 1, wherein the PSSR is located at an ownship aircraft or on the ground.

4. The system of claim 1, wherein the ownship is equipped with one of:
Global Positioning System (GPS); or
ADS-B Out functionality;
for determining the position of the ownship.

5. The system of claim 1, wherein the beam of the SSR is a main beam of the SSR.

6. The system of claim 1, wherein the beam of the SSR is a Side Lobe Suppression (SLS) omni directional beam of the SSR.

7. The system of claim 1 further comprising:
means for receiving a reply from a target aircraft in response to an interrogation signal sent by the SSR to the target aircraft;
estimating a transmit time of the interrogation signal to the target aircraft based on a reception time of said reply, and the PRF pattern; and
means for determining the position of the target aircraft using an altitude information h of the target object contained in said reply, the position of the SSR, said estimated transmit time of the interrogation signal, and said reception time of said reply.

8. A system of claim 1, further comprising means for determining a location of the ownship using two or more opportunistic aircraft interrogated by the same or different SSRs.

9. The system of claim 1 wherein the ownship is blocked from a Line of Sight (LOS) of the SSR.

10. A method for indirect profiling a Secondary Surveillance Radar (SSR), comprising:
at a Passive Secondary Surveillance Radar (PSSR), the PSSR not being able to receive interrogation signals from the SSR:
(a) collecting transponder response signals from an opportunistic aircraft, the opportunistic aircraft being:
(i) equipped with a transponder and has an Automatic Dependent Surveillance-Broadcast (ADS-B) Out functionality;
(ii) in the Line-of-Sight with both the SSR and the PSSR; and
(iii) interrogated, during one or more rotations of the SSR, with interrogation signals from the SSR when the opportunistic aircraft is within a beam of the SSR;
(b) receiving an ADS-B Out response from the opportunistic aircraft and decoding a spatial position of the opportunistic aircraft from the ADS-B Out response;
(c) determining a staggered Pulse Repetition Frequency (PRF) pattern of the SSR using the collected transponder response signals, the decoded spatial position of the opportunistic aircraft, a position of the ownship and a position of the SSR, and a predetermined transponder response time at the opportunistic aircraft.

11. The method of claim 10, wherein the interrogating comprises interrogating at 1030 MHz, and collecting comprises collecting the transponder response signals at 1090 MHz.

12. The method of claim 10, further comprises placing the PSSR at an ownship aircraft, or at a ground base station.

13. The method of claim 10, further comprising determining a location of the ownship using two or more opportunistic aircraft interrogated by the same or different SSRs.

14. The method of claim 10, wherein the beam of the SSR is a main beam of the SSR.

15. The method of claim 10, wherein the beam of the SSR is a Side Lobe Suppression (SLS) omni directional beam of the SSR.

16. The method of claim 10 further comprising:
receiving a reply from the target aircraft in response to an interrogation signal sent by the SSR to the target aircraft;
estimating a transmit time of the interrogation signal to the target aircraft based on a reception time of said reply, and the PRF pattern; and
determining the position of the target aircraft using an altitude information h of the target object contained in said reply, the position of the SSR, said estimated transmit time of the interrogation signal, and said reception time of said reply.

17. The method of claim 10, wherein the ownship is blocked from a Line of Sight (LOS) of the SSR.

18. A Passive Secondary Surveillance Radar (PSSR), not being able to receive interrogation signals from a Secondary Surveillance Radar (SSR), the PSSR comprising:
(a) means for collecting transponder response signals from an opportunistic aircraft to interrogation signals from the SSR during one or more rotations of the SSR;
the opportunistic aircraft is:
(i) equipped with a transponder and has an Automatic Dependent Surveillance-Broadcast (ADS-B) Out functionality;
(ii) in the Line-of-Sight with both the SSR and the PSSR;
(iii) interrogated with the interrogation signals from the SSR, when the opportunistic aircraft is within a beam of the SSR during said one or more rotations of the SSR;
(b) means for receiving an ADS-B Out response from the opportunistic aircraft and decoding a spatial position of the opportunistic aircraft from the ADS-B Out response;
(c) means for determining a staggered Pulse Repetition Frequency (PRF) pattern of the SSR using the collected transponder response signals, the decoded spatial position of the opportunistic aircraft, a position of the ownship and a position of the SSR, and a predetermined transponder response time at the opportunistic aircraft.

19. The PSSR of claim 18, placed on the ground.

20. The PSSR of claim 18, placed on an ownship aircraft.
